(19) United States
(12) Patent Application Publication
(10) Pub. No.: US 2026/0323022 A1
(43) Pub. Date: Oct. 15, 2026

(54) LATENCY REDUCTION FOR CHROMA BLOCKS WITH DECOUPLED PARTITION SCHEME

(71) Applicant: Tencent America LLC, Palo Alto, CA (US)

(72) Inventors: Liang ZHAO, Palo Alto, CA (US); Jayasingam ADHURAN, Palo Alto, CA (US); Shan LIU, Palo Alto, CA (US); Madhu PERINGASSERY KRISHNAN, Palo Alto, CA (US); Tianqi LIU, Palo Alto, CA (US)

(21) Appl. No.: 19/366,408

(22) Filed: Oct. 22, 2025

Related U.S. Application Data
(60) Provisional application No. 63/786,196, filed on Apr. 9, 2025.
(60) Provisional application No. 63/786,847, filed on Apr. 10, 2025.

(51) Int. Cl. H04N 19/119; H04N 19/159; H04N 19/176

(52) U.S. Cl. CPC H04N 19/119; H04N 19/159; H04N 19/176

(57) ABSTRACT

An example method of video coding includes receiving a video bitstream comprising a plurality of blocks including a chroma block. When the chroma block has a same partition direction as a co-located luma block, the method includes reconstructing the chroma block using a cross-component prediction mode. When the chroma block does not have the same partition direction as the co-located luma block, the method includes reconstructing the chroma block without using any cross-component prediction mode.

### RELATED APPLICATIONS

This application claims priority to U.S. Provisional Patent Application No. 63/786,196, entitled “Latency Reduction for Chroma Blocks with Decoupled Partition Scheme,” filed Apr. 9, 2025, and to U.S. Provisional Patent Application No. 63/786,847, entitled “Latency Reduction for Chroma Blocks with Decoupled Partition Scheme,” filed Apr. 10, 2025, each of which is hereby incorporated by reference in its entirety.

### TECHNICAL FIELD

The disclosed embodiments relate generally to video coding, including but not limited to systems and methods for cross-component prediction and block partitioning of video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes methods, systems, and non-transitory computer-readable storage media for applying cross component prediction for video (image) compression. A video codec includes a plurality of function modules for one or more of: intra/inter prediction, transform coding, quantization, entropy coding, and in-loop filtering. In-loop filtering technologies are applied to adjust reconstructed picture samples to further reduce a reconstruction error. Cross-component prediction, such as Chroma-from-Luma (CfL) may be implemented to predict a first component using samples of a second component. However, when a chroma block applies a cross-component prediction, such as CfL, the decoder needs to wait for the availability of the collocated luma samples. The present disclosure describes selectively allowing cross-component prediction mode for chroma blocks based on the block partition of the chroma blocks and the block partition and/or transform partition of the co-located luma blocks. The advantage of selectively allowing cross component prediction modes is reduced luma sample buffering (e.g., from 4 k to 2 k), which reduces the hardware buffer requirement and the decoding delay. For example, if CfL is disallowed, chroma no longer needs to wait until all of the luma samples are reconstructed.

In accordance with some embodiments, a method of video decoding includes: (i) receiving a video bitstream (e.g., a coded video sequence) comprising a plurality of blocks (e.g., corresponding to a set of pictures) including a chroma block; (ii) when the chroma block has a same partition direction as a co-located luma block, reconstructing the chroma block using a cross-component prediction mode; and (iii) when the chroma block does not have the same partition direction as the co-located luma block, reconstructing the chroma block without using any cross-component prediction mode.

In accordance with some embodiments, a method of video encoding includes: (i) receiving video data (e.g., a source video sequence) comprising a plurality of blocks (e.g., corresponding to a set of pictures), including a chroma block; (ii) when the chroma block has a same partition direction as a co-located luma block, encoding the chroma block using a cross-component prediction mode; and (iii) when the chroma block does not have the same partition direction as the co-located luma block, encoding the chroma block without using any cross-component prediction mode.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and/or a decoder component.

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for coding video. Such methods, devices, and systems may complement or replace conventional methods, devices, and systems for video coding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments, and

FIG. 2B is a block diagram illustrating example elements of a decoder component in accordance with some embodiments.

FIG. 3 is a block diagram illustrating an example server system in accordance with some embodiments.

FIGS. 4A-4D illustrate example coding tree structures in accordance with some embodiments.

FIG. 4E illustrates an example of semi-decoupled partitioning in accordance with some embodiments.

FIG. 5A illustrates the computation of a prediction block in accordance with some embodiments.

FIG. 5B illustrates the computation of a residue block in accordance with some embodiments.

FIG. 5C illustrates the computation of a reconstructed block in accordance with some embodiments.

FIG. 6A illustrates an example scheme for generating a chroma sample from a plurality of luma samples in accordance with some embodiments.

FIGS. 6B-6D illustrate example filter shapes of a filter applied to combine luma samples in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a cross-component predictions in video (image) compression. For example, when the chroma block has a same partition direction as a co-located luma block, the chroma block may be reconstructed using a cross-component prediction mode. When the chroma block does not have the same partition direction as the co-located luma block, the chroma block must be reconstructed without using any cross-component prediction mode. In this way, hardware buffer requirements and decoding delays are reduced as chroma components need not wait on luma reconstruction when cross-component prediction is disabled.

This disclosure describes methods for selectively enabling or disabling cross-component prediction modes, such as CfL, for chroma blocks in video coding based on the partition direction of both chroma and co-located luma blocks. By allowing cross-component prediction only when the chroma and luma blocks share the same partition direction at a specified partition node (e.g., 64×64), and disallowing it otherwise, the approach significantly reduces the dependency of chroma block reconstruction on luma sample availability. This selective control leads to a reduction in luma sample buffering requirements, thereby decreasing hardware buffer size and decoding latency. As a result, the system achieves more efficient video decoding with lower memory usage and improved real-time performance, particularly in hardware implementations where minimizing delay and resource consumption is critical.

### Example Systems and Devices

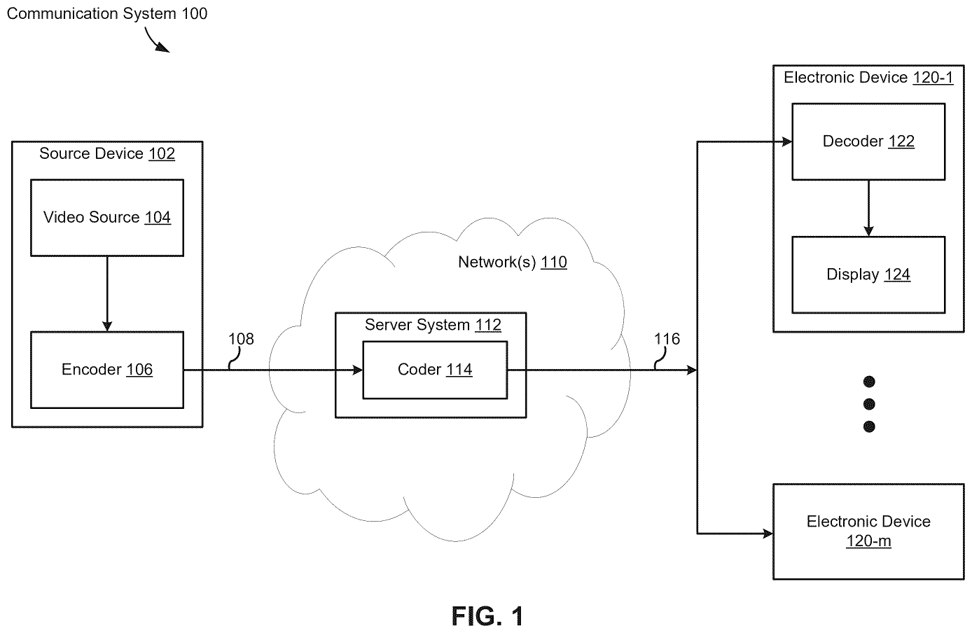

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

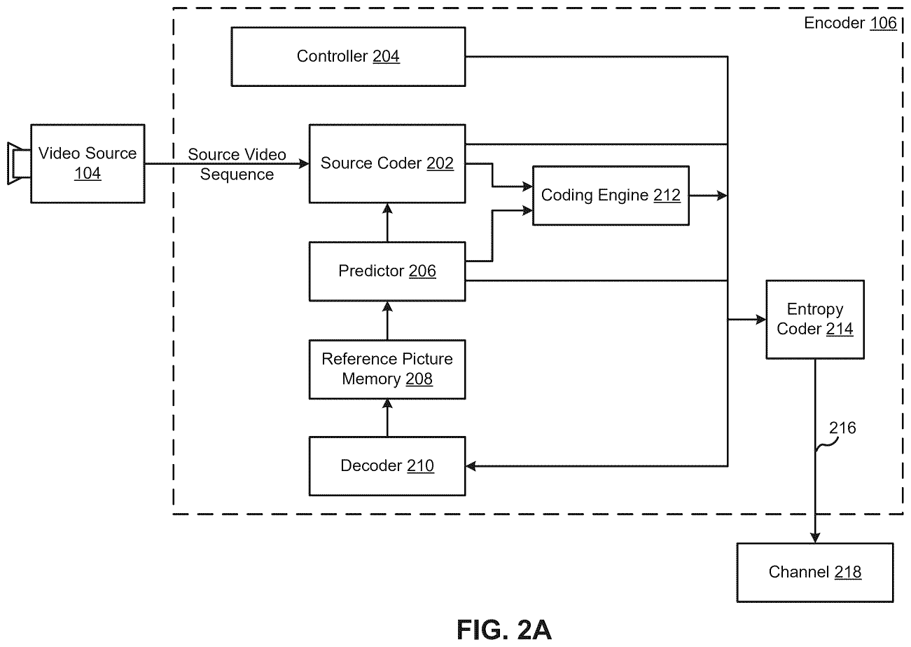

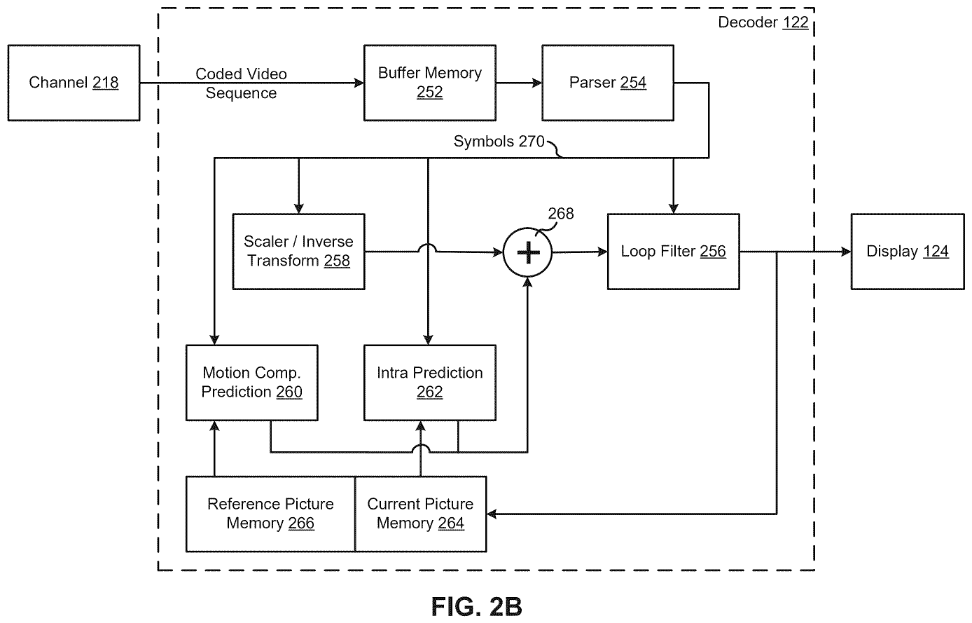

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

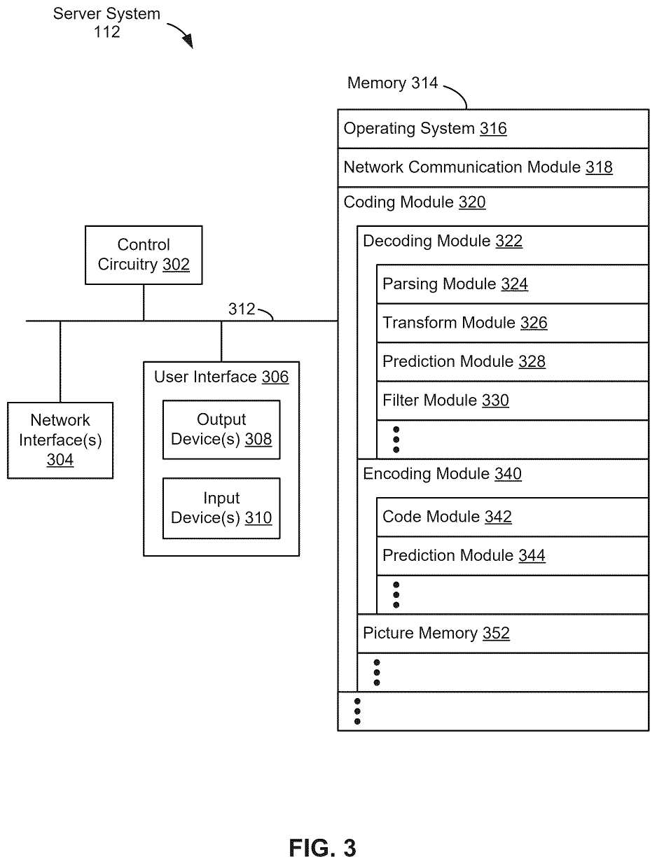

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above, such as an audio processing module.

Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for cross-component prediction and block partitioning are described.

Cross-component prediction in video coding is a technique that leverages the correlation between different color components, typically luma and chroma, to improve compression efficiency. In this approach, chroma samples are predicted using reconstructed luma samples from co-located blocks, often through a linear model or other mathematical relationships. By exploiting the inherent redundancy between color channels, cross-component prediction reduces the amount of data required to represent chroma information, leading to lower bitrates and improved coding performance. This method is commonly implemented in modern video codecs as part of the prediction and filtering stages, enabling more accurate reconstruction of chroma blocks and enhancing overall visual quality while maintaining efficient resource utilization.

In the following, when saying a block or a sub-block, it may refer to the coding block with the biggest coding block size (such as a superblock, or largest coding unit, or coding tree block), or a coding block, or a prediction block, or a transform block, or a filtering unit. When saying a sub-block of a block A, it refers to a block whose area is fully contained in block A. A block region refers to a specific block area which contains at least one block, or at least multiple blocks. A region type refers to an enclosed set of luma and chroma blocks. When all of the luma blocks in the enclosed block set are intra coded, the region type is referred to as INTRA. If at least one of the blocks in the enclosed set is inter coded, then the region type is referred to as MIXED_INTER_INTRA.

Block and transform partitioning are described next. Partitioning refers to splitting a coding block into a single or multiple smaller blocks. Block partitioning and transform partitioning are distinct processes in video coding. Block partitioning refers to dividing a video frame into smaller spatial regions, or blocks, which are then individually processed for prediction and encoding. This enables the codec to adapt to local image characteristics and efficiently exploit spatial and temporal redundancies.

Transform partitioning, on the other hand, involves subdividing these blocks further for the purpose of applying mathematical transforms, such as discrete cosine transforms, to the residual data after prediction. While block partitioning optimizes prediction accuracy and coding flexibility, transform partitioning is focused on improving the efficiency of residual data representation and compression. Transform block partition type may correspond to partitions used to divide the coded block into one or multiple transform blocks. A transform partition may correspond to none partition, split partition, a square partition, a horizontal binary partition, a vertical binary partition, a three-way horizontal partition and a three-way vertical partition.

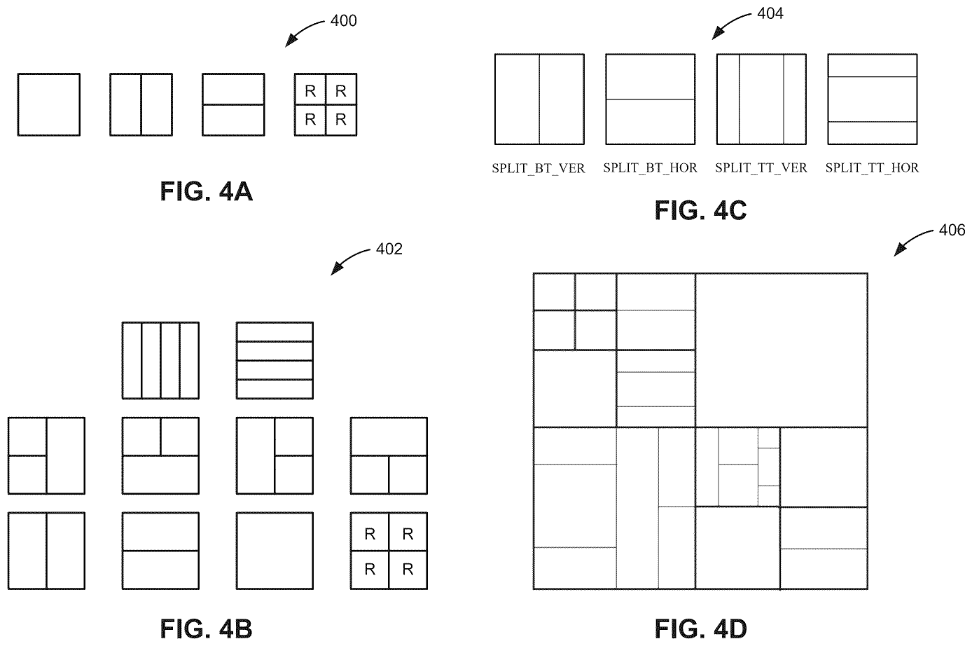

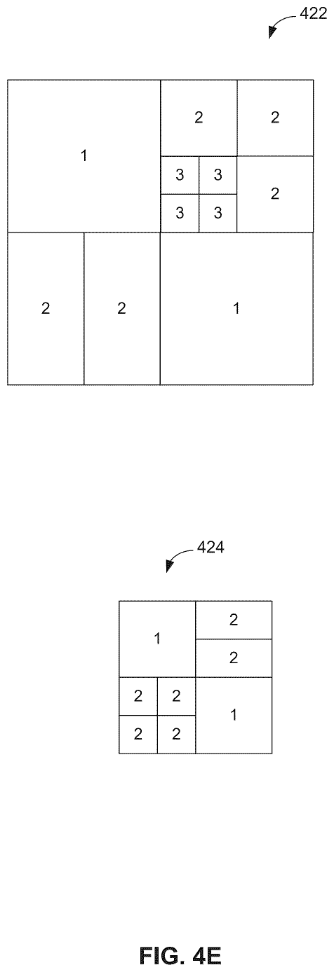

FIGS. 4A-4D illustrate example coding tree structures in accordance with some embodiments. As shown in a first coding tree structure (400) in FIG. 4A, some coding approaches (e.g., VP9) use a 4-way partition tree starting from a 64×64 level down to a 4×4 level, with some additional restrictions for blocks 8×8. In FIG. 4A, partitions designated as R can be referred to as recursive in that the same partition tree is repeated at a lower scale until the lowest 4×4 level is reached. As shown in a second coding tree structure (402) in FIG. 4B, some coding approaches (e.g., AV1) expand the partition tree to a 10-way structure and increase the largest size (e.g., referred to as a superblock in VP9/AV1 parlance) to start from 128×128. The second coding tree structure includes 4:1/1:4 rectangular partitions that are not in the first coding tree structure. The partition types with 3 sub-partitions in the second row of FIG. 4B are referred to as T-type partitions. In addition to a coding block size, coding tree depth can be defined to indicate the splitting depth from the root note.

As an example, a CTU may be split into CUs by using a quad-tree structure denoted as a coding tree to adapt to various local characteristics, such as in HEVC. In some embodiments, the decision on whether to code a picture area using inter-picture (temporal) or intra-picture (spatial) prediction is made at the CU level. Each CU can be further split into one, two, or four PUs according to the PU splitting type. Inside one PU, the same prediction process is applied, and the relevant information is transmitted to the decoder on a PU basis. After obtaining the residual block by applying the prediction process based on the PU splitting type, a CU can be partitioned into TUs according to another quad-tree structure like the coding tree for the CU.

A quad-tree with nested multi-type tree using binary and ternary splits segmentation structure may replace the concepts of multiple partition unit types, e.g., it removes the separation of the CU, PU, and TU concepts except as needed for CUs that have a size too large for the maximum transform length, and supports more flexibility for CU partition shapes. In the coding tree structure, a CU can have either a square or rectangular shape. A CTU is first partitioned by a quaternary tree (also referred to as quad-tree) structure. The quaternary tree leaf nodes can be further partitioned by a multi-type tree structure. A third coding tree structure (404) in FIG. 4C shows the multi-type tree structure includes four splitting types. The multi-type tree leaf nodes are called CUs, and unless the CU is too large for the maximum transform length, this segmentation is used for prediction and transform processing without any further partitioning. This means that, in most cases, the CU, PU, and TU have the same block size in the quad-tree with nested multi-type tree coding block structure. An example of block partitions for one CTU (406) is shown in FIG. 4D, which illustrates an example quadtree with nested multi-type tree coding block structure.

The following partition modes may be used:
PARTITION_NONE=No splitting of the coding block
PARTITION_SPLIT=Splitting of a square coding block into four square blocks.
PARTITION_VERT=Vertically splitting of a coding block into two equally sized blocks.
PARTITION_HORZ=Horizontally splitting of a coding block into two equally sized blocks.
PARTION_VERT_3=Vertically splitting of a coding block into three blocks with width ratio 1:2:1. Centre block is further horizontally split into two equally sized blocks.
PARTION_HORZ_3=Horizontally splitting of a coding block into three blocks with height ratio 1:2:1. Centre block is further vertically split into two equally sized blocks.
PARTION_VERT_4A=Vertically splitting of a coding block into four blocks with width ratio 1:2:4:1.
PARTION_VERT_4B=Vertically splitting of a coding block into four blocks with width ratio 1:4:2:1.
PARTION_HORZ_4A=Horizontally splitting of a coding block into four blocks with height ratio 1:2:4:1.
PARTION_HORZ_4B=Horizontally splitting of a coding block into four blocks with height ratio 1:4:2:1.

As used herein, the phase “semi-decoupled partitioning” (SDP) may refer to a block region in which the luma block and a chroma block share the same partitioning information for the first N levels of the block partitioning and have separate block partitioning (e.g., different block partitions) starting from a partitioning point, called the decoupled partitioning point. The decoupled partitioning point may be implicitly determined based on the partitioning information of the luma block. FIG. 4E shows an example of semi-decoupled partitioning in accordance with some embodiments. The left side of FIG. 4E shows a coding tree structure for a luma component (e.g., a luma block 422) and the right side of FIG. 4E shows a coding tree structure for a chroma component (e.g., a chroma block 424). The numerical values within each block or subblock of the luma block 422 and the chroma block 424 in FIG. 4E indicate the depth of the block partitioning. As is shown, both the luma block 422 and the chroma block 424 share the quad-tree split (e.g., PARTITION_SPLIT, corresponding to the numeral “1”) at the beginning of the super block/coding tree structure. At a depth of 2, a lower left block of the chroma block 424 undergoes another quad-tree split, while an upper right block of the chroma block 424 undergoes a horizontal split (e.g., PARTITION_HORZ). In contrast, a lower left block of the luma block 422 undergoes a vertical split (e.g., PARTITION_VERT), while an upper right block of the luma block 422 undergoes another quad-tree split. The luma block 422 includes another partition at a depth of 4, where the lower left block of the quad-tree split from the depth of 2 is partitioned by yet another quad-tree split at a depth of 3. As a result, the coding tree structure of the luma block and the coding tree structure of the chroma block in FIG. 4E start to have separate block partitioning from that point or from block partitioning depth 1. In some approaches, SDP is applied to key frames and intra region in inter frames. With SDP, a luma block and a chroma block may have different block partitioning starting from 64×64.

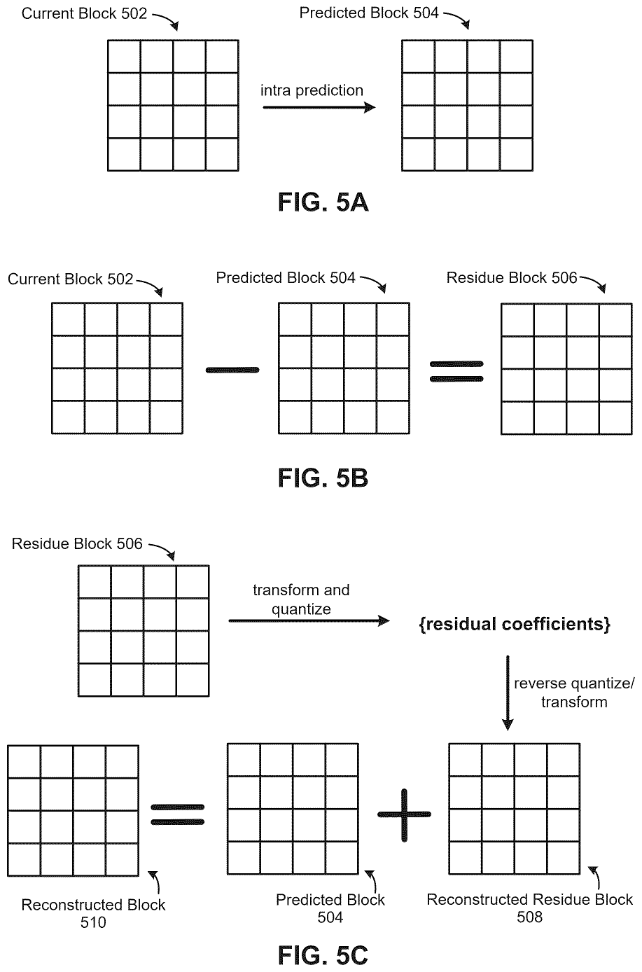

Turning now to example encoding and decoding using prediction and residual blocks, FIG. 5A illustrates the computation of a prediction block in accordance with some embodiments. In the example of FIG. 5A, an intra prediction is performed on a current block 502 to generate a predicted block 504. The current block 502 includes a set of samples (e.g., pixel blocks) and the prediction block 504 includes a set of predictions that correspond to the set of samples. FIG. 5B illustrates the computation of a residue block in accordance with some embodiments. As shown in FIG. 5B, the prediction block 504 is subtracted from the current block 502 to generate a residue block 506 that includes a set of residues. For example, respective differences are calculated between each sample and the corresponding prediction. FIG. 5C illustrates the computation of a reconstructed block in accordance with some embodiments. As shown in FIG. 5C, the residue block 506 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 508. The reconstructed residue block 508 is combined with the predicted block 504 (e.g., reconstructed residues of the reconstructed residue block 508 are added to predictions of the prediction block 504) to generate a reconstructed block 510 corresponding to the current block 502.

Notably, the transforms performed during decoding of the video bitstream may be inverses of the transformed performed during encoding of the video bitstream and are sometimes referred to as “inverse transforms”. For simplicity, the transformations described herein may be referred to as “transforms” whether performed during encoding or decoding.

Turning now to cross-component predictions, chroma from luma (CfL) refers to a general methodology where chroma block samples are predicted from the reconstructed samples from collocated luma blocks. The CfL prediction mode derives chroma prediction samples using their collocated reconstructed luma samples via a linear model. In CfL mode, the scaling factors may be explicitly signaled into the bitstream or implicitly derived from the neighboring reconstructed samples. Additionally, Multi-hypothesis cross component prediction (MHCCP) mode can also be considered as a type of CfL mode.

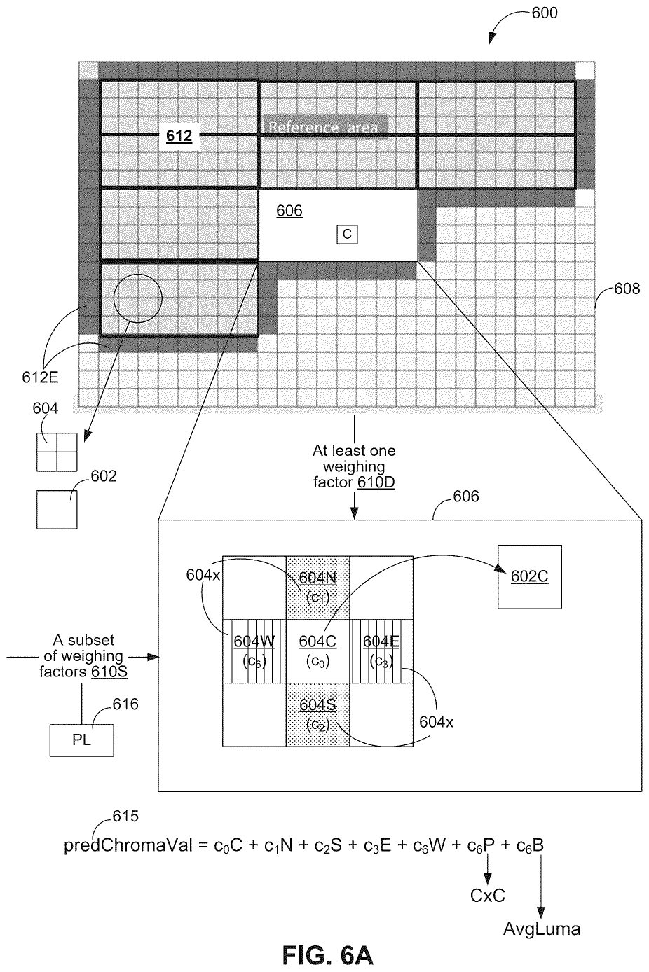

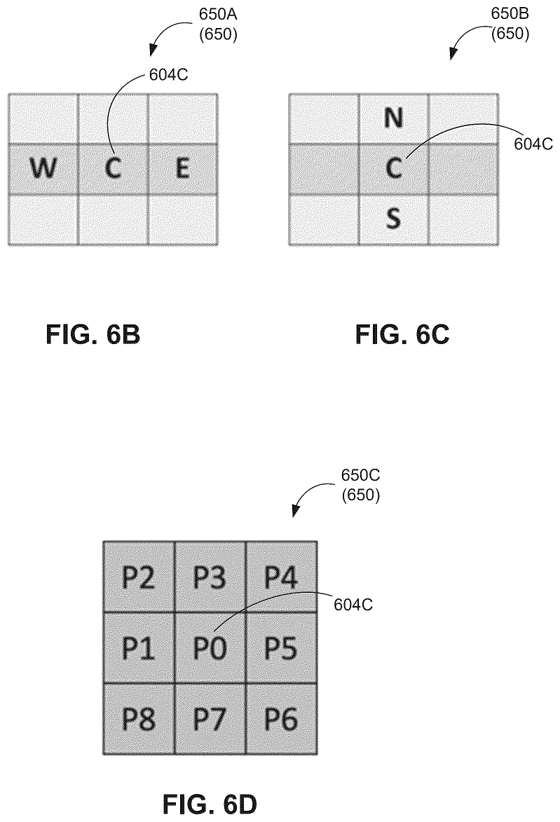

FIG. 6A illustrates an example scheme 600 for generating a chroma sample 602 from a plurality of luma samples 604 in accordance with some embodiments. In some embodiments, a current coding block 606 of a current image frame 608 is coded in a cross-component prediction mode. In the cross-component mode, a decoder determines each chroma sample 602 of the current coding block 606 based on one or more luma samples 604 that have been reconstructed. In some embodiments, a first chroma sample 602C is generated by combining a plurality of reconstructed luma samples 604 (e.g., samples 604C, 604N, 604S, 604W, and 604E) using a plurality of weighing factors (cᵢ). The plurality of reconstructed luma samples includes a first luma sample 604C of the current coding block 606 that is co-located with the first chroma sample 602C and a plurality of neighboring luma samples 604x that is located adjacent to the first luma sample 604C based on a filter shape of a filter. In some embodiments, at least one weighing factor 610S of a plurality of weighing factors 610 of the filter corresponds to at least one neighboring luma sample 604x. The decoder may extract the at least one weighing factor 610S from a video bitstream received from an encoder. In some situations, at least another weighing factor 610D is not signaled in the video bitstream. The decoder derives the at least another weighing factor 610D, e.g., based on a reference area 612 of the current coding block 606 in the current image frame 608. The first luma sample 602C and the plurality of neighboring luma samples 604x are combined based on the at least one weighing factor 610S that is signaled in the video bitstream and the at least another weighing factor 610D that is not signaled in the video bitstream to generate the first chroma sample 602C. The decoder reconstructs the current coding block 606 including the first chroma sample 602C.

The filter shape of the filter determines a number of the plurality of neighboring luma samples 604x and their locations with respect to the first luma sample 604C. For example, a cross-shaped 5-tap filter has five inputs consists of the first luma sample 604C that is collocated with the chroma sample 602C to be predicted and four neighboring luma samples 604x, including a north/above neighboring sample 604N, a south/below neighboring sample 604S, a west/left neighboring sample 604W, and an east/right neighboring sample 604E. Each of the first luma sample 604C and neighboring luma samples 604x corresponds to a respective weighing factor (e.g., c₀, c₁, c₂, c₃, or c₄), which is also referred to as a filter coefficient. The plurality of weighing factors includes the weighing factors (e.g., c₀-c₄) applied as filter coefficients in the filter and two additional weighing factors (e.g., c₅, c₆), such that a weighted combination is determined for linear components of luma samples 604C and 604x, a nonlinear term P, and a bias term B. In some embodiments, a weighing factor co corresponding to the first luma sample 604C is greater than remaining weighing factors (e.g., c₁-c₆) of the plurality of weighing factors. The nonlinear term P represents a square of the first luma sample 604C that is scaled to a sample value range as follows:

P=(C*C+midVal)>>bitDepth (1)

where C represents a value of the first luma sample 604C, midVal represents an integer to which an average of two bounds of a range of luma values is rounded, and bitDepth is a bit depth of the luma values. For example, the bit depth of the luma value is 10, and the nonlinear term P can be represented as:

P=(C*C+512)>>10 (2)

The bias term B represents a scalar offset between the inputs and output, and for example, is set to a middle chroma value (512 for 10-bit content). In some embodiments, an output of the filter is determined as a convolution between the filter coefficients and the inputs (e.g., the first luma sample 604C and neighboring luma samples 604x), and clipped to a range of valid chroma samples 604.

In some embodiments, the at least one weighing factor 610S that is signaled with the video bitstream and includes all of the plurality of weighing factors applied to generate the first luma sample 602C. For example, the filter shape of the filter is a cross shape and has 5 taps. In accordance with the filter shape, the plurality of neighboring luma samples 404x includes four neighboring luma samples 604N, 604S, 604W, and 604E arranged in the cross shape centered at the first luma sample 604C. Further, in some embodiments, the plurality of weighing factors of the filter includes 7 weighing factors corresponding to the first luma sample 604C, the four neighboring luma samples 604x, an output of a non-linear function of the first luma sample 604C (e.g., P), and a bias component (e.g., B), respectively. In some situations, all of the 7 weighing factors applied to generate the first chroma sample 602C based on the equation 615 are signaled with the video bitstream, e.g., none of the 7 weighing factors are derived locally by the decoder. In some embodiments, the cross-component mode includes a multi-chroma from luma (multi-CfL) mode. The decoder determines that the current coding block 606 is encoded in the multi-CfL mode. In accordance with a determination that the current coding block 606 is encoded in the multi-CfL mode, the filter and the plurality of neighboring luma samples 604x of the first luma sample 604 of the current coding block 606 are identified. The first chroma sample 604C of the current coding block 606 is a weighted sum of the first luma sample 604C, the plurality of neighboring luma samples 604x, an output of a non-linear function of the first luma sample 604C, and a bias component B. In some embodiments, the bias component B is equal to an average of luma samples of the reference area 612.

In some embodiments, the plurality of weighing factors (e.g., c0-c6 in equation 615) is determined by minimising a mean square error (MSE) between predicted and reconstructed chroma samples 602 in the reference area 612. The MSE minimization is performed by calculating autocorrelation matrix for the luma samples 604 and a cross-correlation vector between the luma samples 604 and chroma samples 602 in the reference area 612. Autocorrelation matrix is processed with LDL decomposition and the plurality of weighing factors is calculated using back-substitution. The process follows roughly the calculation of filter coefficients of an adaptive loop filter (ALF) in some video coding. LDL decomposition does not use square root operations and uses only integer arithmetic operations. In some embodiments, usage of the cross-component mode is signaled in the video bitstream with a context-adaptive binary arithmetic coding (CABAC) coded flag on a prediction unit level.

In some embodiments, the reference area 612 of the current coding block 606 includes one or more of: a top left reference region, a top reference region, a top right reference region, a bottom left reference region, and a left reference region. In some embodiments, the reference area 612 includes at least a portion of a plurality of rows above the current coding block 606 and/or a portion of a plurality of columns to the left of the current coding block 606.

FIGS. 6B-6D illustrate example filter shapes 650A-650C of a filter 650 applied to combine luma samples 604 in a cross-component mode in accordance with some embodiments. Each filter shape 650A-650C is optionally applied to the current image frame 608, a slice of the current image frame 608, a superblock including the current coding block 606, or the current coding block 606. Referring to FIG. 6B, the filter shape 650A corresponds to an odd number of horizontal luma samples (e.g., 3 horizontal luma samples 604W, 604C, and 604E) centered at the first luma sample 404C (P0). Referring to FIG. 6C, the filter shape 650B corresponds to an odd number of vertical luma samples (e.g., 3 vertical luma samples 604N, 604C, and 604S) centered at the first luma sample 604C (P0). Referring to FIG. 6D, the filter shape 650C corresponds to an array of 3×3 luma samples (P0-P8), which is centered at the first luma sample 604C (P0).

In some embodiments, the filter shape applied to combine the first luma sample 604C and a plurality of neighboring luma samples 604x is determined based on the block size of the current block. For example, the block size of the current coding block 606 is less than a predefined block threshold, and the filter 650 includes a first filter having a first factor number of weighing factors. In some embodiments, the block size is greater than a predefined block threshold, and the filter includes a second filter having a second factor number of weighing factors. The second filter has a different filter shape from the first filter. The second factor number is smaller than the first factor number.

In some embodiments, the current coding block has a first block size greater than a predefined block threshold, and a second coding block has a second block size less than or equal to the predefined block threshold. A first filter applied to the first coding block has a first factor number of weighing factors. A second filter applied to the second coding block includes a second factor number of weighing factors. The second factor number is greater than the first factor number, and the second filter has a shape different from the first filter. In some embodiments, the first filter has a higher precision level than the second filter. In some embodiments, during encoding, the encoder selects the filter shape based on the block size of the current coding block 606. For example, the encoder compares a block size of the current coding block 606 to determine whether the first filter or the second filter is used to generate the chroma samples 602 from the luma samples 604 of the current coding block 606.

In some embodiments, the filter applied to generate the first chroma sample 602C is selected from a first filter and a second filter, and the first filter corresponds to a smaller number of weighing factors, and has a higher precision level, than the second filter. In some embodiments, during encoding, the encoder selects the precision level based on the filter shape of the current coding block 606C. For example, a higher number of weighing factors for the filter results in a lower precision level each weighing factor.

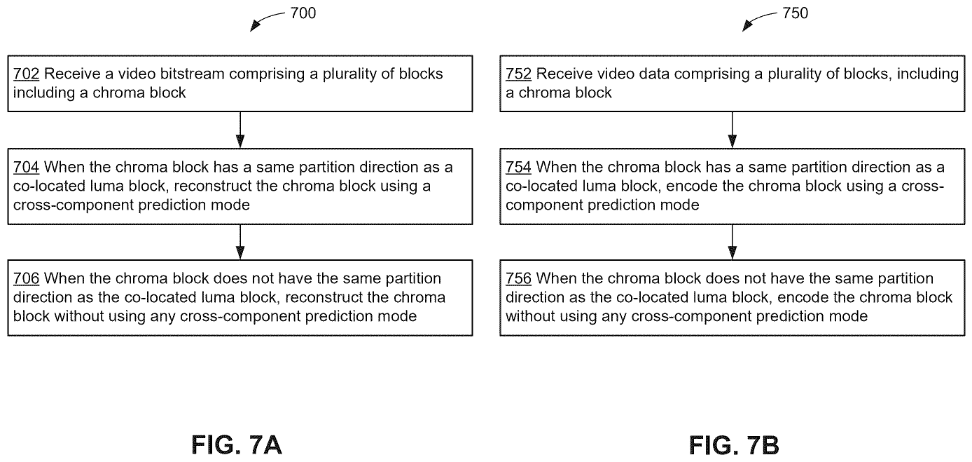

FIG. 7A is a flow diagram illustrating a method 700 of decoding video in accordance with some embodiments. The method 700 may be performed at a computing system (e.g., the server system 112, the source device 102, or the electronic device 120) having control circuitry and memory storing instructions for execution by the control circuitry. In some embodiments, the method 700 is performed by executing instructions stored in the memory (e.g., the memory 314) of the computing system.

The system receives (702) a video bitstream (e.g., a coded video sequence) comprising a plurality of blocks (e.g., corresponding to a set of pictures), including a chroma block. When the chroma block has a same partition direction as a co-located luma block, the system reconstructs (704) the chroma block using a cross-component prediction mode. When the chroma block does not have the same partition direction as the co-located luma block, the system reconstructs (706) the chroma block without using any cross-component prediction mode. In some embodiments, the system determines whether the chroma block has a same partition direction as a co-located luma block. In accordance with a determination that the chroma block has the same partition direction as the co-located luma block, the cross-component prediction mode is allowed for the chroma block. In accordance with a determination that the chroma block does not have the same partition direction as the co-located luma block, the cross-component prediction mode is disallowed for the chroma block. In this way, a decoder may selectively allow or disallow cross-component prediction mode for chroma blocks based on the block partition of the chroma blocks and the block partition and/or transform partition of the co-located luma blocks.

When a chroma block applies cross component prediction, such as CFL, the decoder needs to wait for the availability of the collocated luma samples. The methods described herein selectively allow or disallow cross component prediction mode for chroma blocks based on the block partition of the chroma blocks and the block partition and/or transform partition of the co-located luma blocks.

In some embodiments, cross component prediction is allowed for all the child nodes of chroma blocks at one partition node when the co-located luma and chroma blocks have the same block partition directions at the partition node. For example, the partition node can be 64×64, 32×64, 64×32, or 32×32

In some embodiments, the partition direction of horizontal binary split, horizontal H-shape, and horizontal uneven 4-way split (includes both horizontal uneven 4-way A split and uneven 4-way B split) is horizontal direction. In some embodiments, the partition direction of vertical binary split, vertical H-shape, and vertical uneven 4-way split (including both vertical uneven 4-way A split and uneven 4-way B split) is vertical direction. In some embodiments, cross component prediction is allowed for chroma blocks when the luma and chroma blocks have the same block partition directions from the first split at 64×64 (or 64×32 or 32×64) level. For example, at 64×64 level, luma is using horizontal binary split, and chroma is using horizontal H-shape split, and cross component prediction is allowed for all the child nodes for chroma block under this 64×64 node.

In some embodiments, when luma and chroma blocks have the same direction, either both horizontal directions or both vertical directions, at 64×64 (or 64×32 or 32×64) level, cross component prediction is enabled for chroma blocks regardless of the transform partition split of the luma blocks. In some embodiments, cross component prediction is disallowed for chroma blocks when the luma and chroma blocks have different block partition directions from the first split at 64×64 (or 64×32 or 32×64) level. For example, at 64×64 level, luma is using horizontal binary split, and chroma is using vertical H-shape split, and cross component prediction is not allowed for all the child nodes for chroma block under this 64×64 node.

In some embodiments, when chroma blocks are not split at 64×64 (or 64×32 or 32×64) block partition node, cross component prediction mode is allowed for all the nodes chroma blocks under this 64×64 (or 64×32 or 32×64) node regardless of the co-located luma block partition and transform partition.

In some embodiments, when there is no block partition split and no transform partition split for the co-located luma blocks at 64×64 (or 64×32 or 32×64) block partition node, cross component prediction mode is allowed for all the child chroma blocks under this 64×64 (or 64×32 or 32×64) block partition node regardless of the block partition for chroma blocks.

In some embodiments, when there is no block partition split at 64×64 (or 64×32 or 32×64) block partition node for co-located luma blocks, the transform partition direction for luma blocks is X, either horizontal or vertical, and the block partition of the chroma blocks at 64×64 (or 64×32 or 32×64) block partition node is perpendicular to X, cross component prediction is not allowed for chroma blocks.

In some embodiments, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is one kind of partition split, cross component prediction is not allowed for chroma blocks.

In some embodiments, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is not partition_none and horizontal split, cross component prediction is not allowed for chroma blocks.

In some embodiments, cross component prediction is allowed for all the child nodes of chroma blocks at 64×64 (or 64×32 or 32×64) level when the co-located luma and chroma blocks have the same block partition directions at 64×64 (or 64×32 or 32×64) level.

In some approaches, when a chroma block applies CFL, the decoder needs to wait for the availability of the collocated luma samples. In some embodiments, this latency is reduced by selectively disallowing CFL for chroma blocks. In some embodiments, disallowing CFL may depend on the region type of the current block. In some embodiments, CFL is allowed in inter frames when the region type is MIXED_INTER_INTRA.

In some embodiments, disallowing CFL may depend on the luma and/or chroma block partitions. In some embodiments, disallowing CFL may depend on the decoupled partitioning point between luma and chroma blocks. In some embodiments, CFL mode is allowed if the decoupled partitioning point is lower or equal to 32×32.

In some embodiments, disallowing CFL may depend on both luma and chroma partitions. In some embodiments, when luma and chroma have different partitions, CFL may be disallowed. Otherwise, when luma and chroma have the same block partitions, CFL mode is allowed.

In some embodiments, disallowing CFL may depend on the block size of the co-located luma block. In some embodiments, when both the block width and block height of the co-located luma block is equal to or greater than one threshold T1, CFL mode is disallowed for the chroma block. In one example, T1 is set to 64. In some embodiments, when the sample area size of the co-located luma block is equal to one threshold T2, CFL mode is disallowed for the chroma block. In one example, T2 is set to 64×32.

In some embodiments, disallowing CFL may depend on whether a chroma block partition is different from its co-located luma block partition. In some embodiments, when the chroma partition is different from the luma partition, CFL is allowed. In some embodiments, disallowing CFL may depend on the imposition of partitioning from luma and the block size. In some embodiments, when the chroma block is imposed with the luma partition and the block size T1, CFL is disallowed. In one example, T1 is 64×32. In some embodiments, disallowing CFL may depend on the imposition of partitioning from luma and the mapping between luma and chroma partitions. In some embodiments, if the chroma block is not imposed with the luma partition, a combination of the chroma block partition and its co-located luma block partitions may be used to derive the decision to disallow CFL.

In some embodiments, disallowing CFL may depend on the combination of chroma block partition and its co-located luma block partitions. This combination can be implemented by a look-up mapping table. In some embodiments, for a given luma partition A, CFL is allowed for leaf node situated on chroma partitions A, B, C. In one example, A, B and C can be (but not limited to) PARTITON_HORZ, PARTION_HORZ 3 and PARTITION_HORZ_4A. In some embodiments, the number of chroma partitions can be as many as the number of existing block partitions. In some embodiments, A can be any existing block partition.

In some embodiments, multiple partition mappings between Luma and Chroma may depend on the block size. In some embodiments, for a given Luma partition A, CFL is allowed for leaf node situated on Chroma partitions A, B, C only when the sample area size of the co-located luma block is equal to one threshold T1. In one example, A, B and C can be (but not limited to) PARTITON_HORZ, PARTION_HORZ 3 and PARTITION_HORZ 4A and T1 is set to 64×32.

In some embodiments, a look-up table may be used for multiple partition mappings between luma and chroma partitions and the co-located luma block size. In some embodiments, the look-up table may be used to retrieve multiple chroma partitions for a give luma partition A and block size T1. In some embodiments, a look-up table is used to retrieve PARTITION_VERT 4B, PARTITION_NONE and PARTITION_HORZ if A is PARTION_VERT_4B and T1 is 64×32. In some embodiments, the look-up table may be as shown in Table 1.

TABLE 1
Example depiction of look-up table to map luma and chroma partitions

| | Luma block size | Luma block size | Luma block size |
|---|---|---|---|
| Luma Partition | 64 × 64 | 64 × 32 | 32 × 64 |
| PARTITION_NONE | PARTITION_NONE, | PARTITION_NONE, | PARTITION_NONE, |
| | PARTITION_HORZ, | PARTITION_VERT, | PARTITION_HORZ, |
| | PARTITION_HORZ_3, | PARTITION_VERT_3, | PARTITION_HORZ_3, |
| | PARTITION_HORZ_4A, | PARTITION_VERT_4A, | PARTITION_HORZ_4A, |
| | PARTITION_HORZ_4B | PARTITION_VERT_4B | PARTITION_HORZ_4B |
| PARTITION_HORZ | PARTITION_HORZ, | PARTITION_HORZ, | All except |
| | PARTITION_NONE, | PARTITION_HORZ_3, | PARTITION_SPLIT |
| | PARTITION_HORZ_3, | PARTITION_HORZ_4A, | |
| | PARTITION_HORZ_4A, | PARTITION_HORZ_4B | |
| | PARTITION_HORZ_4B | | |
| PARTITION_VERT | PARTITION_VERT, | All except | PARTITION_VERT, |
| | PARTITION_VERT_3, | PARTITION_SPLIT | PARTITION_VERT_3, |
| | PARTITION_VERT_4A, | | PARTITION_VERT_4A, |
| | PARTITION_VERT_4B | | PARTITION_VERT_4B |
| PARTITION_HORZ_3 | PARTITION_HORZ_3, | PARTITION_HORZ_3, | PARTITION_HORZ_3, |
| | PARTITION_HORZ_4A, | PARTITION_NONE, | PARTITION_NONE, |
| | PARTITION_HORZ_4B | PARTITION_HORZ, | PARTITION_HORZ, |
| | | PARTITION_HORZ_4A, | PARTITION_HORZ_4A, |
| | | PARTITION_HORZ_4B | PARTITION_HORZ_4B |
| PARTITION_VERT_3 | PARTITION_VERT_3, | PARTITION_VERT_3, | PARTITION_VERT_3, |
| | PARTITION_VERT_4A, | PARTITION_NONE, | PARTITION_NONE, |
| | PARTITION_VERT_4B | PARTITION_VERT, | PARTITION_VERT, |
| | | PARTITION_VERT_4A, | PARTITION_VERT_4A, |
| | | PARTITION_VERT_4B | PARTITION_VERT_4B |
| PARTITION_HORZ_4A | PARTITION_HORZ_4A | PARTITION_HORZ_4A | PARTITION_HORZ_4A |
| PARTITION_HORZ_4B | PARTITION_HORZ_4B | PARTITION_HORZ_4B | PARTITION_HORZ_4B, |
| | | | PARTITION_NONE, |
| | | | PARTITION_HORZ |
| PARTITION_VERT_4A | PARTITION_VERT_4A | PARTITION_VERT_4A | PARTITION_VERT_4A |
| PARTITION_VERT_4B | PARTITION_VERT_4B | PARTITION_VERT_4B, | PARTITION_VERT 4B |
| | | PARTITION_NONE, | |
| | | PARTITION_HORZ | |

| | |
|---|---|
| PARTITION_SPLIT | Not Applicable |

In some embodiments, disabling CFL may depend on the look-up table. In some embodiments, when the chroma partition and the partition derived from the look-up table using the block size of the luma block and the luma partition are different, CFL is disallowed. In some embodiments, when the chroma partition and at least one of the partitions derived from the look-up table using the block size of the luma block and the luma partition are different, CFL is disallowed.

In some embodiments, disallowing CFL may depend on the luma tree. In some embodiments, CFL mode is disallowed for child nodes if the referencing between parent tree of the luma partition is disallowed by the encoder.

In some embodiments, disallowing CFL may depend on the parent tree. In some embodiments, CFL mode is disallowed if the leaf node does not have a parent tree. In some embodiments, disallowing CFL may depend on the parent tree of the luma partition. In some embodiments, CFL mode is disallowed for a leaf node at a block size T1 if the partition of the parent tree of collocated luma block is B. For example, T1 is set to 16×16, and B is PARTITION_HORZ.

In some embodiments, disallowing CFL may depend on the parent tree of the luma partition and the block partition of the current tree. In some embodiments, the mapping between parent tree of the luma partition and the block partition of the current tree applies a lookup mapping table (e.g., Table 1).

In some embodiments, disallowing CFL depends on a combination of the factors described above. In some embodiments, the decoupled partitioning point between luma and chroma blocks is first checked before the other checks described herein. In some embodiments, combining the decisions (e.g., determinations at various checks) may include applying logical operations. In some embodiments, if one of the conditions for block size of the co-located luma block, whether the chroma block partition is different from its co-located luma block partition or the combination of chroma block partition and its co-located luma block partitions returns true, CFL is allowed for that block. In some embodiments, the decision to disallow CFL is taken at each depth of the partition tree. In some embodiments, the decision to disallow CFL depends on the luma and/or chroma block partition. In some embodiments, the decision to disallow CFL is passed down to the child tree.

In some embodiments, disallowing CFL may depend on the decision taken at various partitions depths di, (i={1, 2, 3, 4, . . . n}, where n refers to the leaf node as selected by the encoder). In some embodiments, the decision taken to disallow CFL may be combined using logical operators. In some embodiments, when the decisions taken at d1, d3 and dN are false, true, and false, CFL is still allowed for the leaf node regardless of the decision taken at leaf node.

FIG. 7B is a flow diagram illustrating a method 750 of encoding video in accordance with some embodiments. The method 750 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 750 is performed by a same system as the method 700 described above.

The system receives (752) video data comprising a plurality of blocks, including a chroma block. When the chroma block has a same partition direction as a co-located luma block, the system encodes (754) the chroma block using a cross-component prediction mode. When the chroma block does not have the same partition direction as the co-located luma block, the system encodes (756) the chroma block without using any cross-component prediction mode. As described previously, the encoding process may mirror the decoding processes described herein (e.g., partitioning and prediction). For brevity, those details are not repeated here.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

Turning now to some example embodiments.

In some embodiments, with semi-decoupled partitioning, luma and chroma blocks can have separate block partitioning starting from 64×64. Moreover, CfL is a chroma coding tool that applies collocated luma reconstructed samples in predicting chroma samples. In the worst case, the decoding process of chroma blocks needs to wait until the decoding process of collocated luma blocks is completed. The techniques described herein reduce the latency between chroma block and collocated luma by restricting the use of CfL mode based on luma and chroma partition types. Simulations have been conducted using research-v9.0.0 anchor, and the results are summarized in Table 2.

TABLE 2

| | Y-PSNR | U-PSNR | V-PSNR | YUV-PSNR | Enc-time | Dec-time |
|---|---|---|---|---|---|---|
| AI | 0.04% | 0.47% | 0.47% | 0.09% | 99% | 97% |
| RA | 0.01% | 0.40% | 0.23% | 0.04% | 99% | 98% |
| LD | 0.00% | 0.37% | 0.23% | 0.02% | 99% | 97% |

In some embodiments, SDP is applied to key frames and intra region in inter frames. With SDP, luma and chroma may have different block partitioning starting from 64×64. As described above, a latency is introduced during the decoding process of chroma blocks as they need to wait until the decoding process of collocated luma blocks is finished. To address the decoder latency issue, CfL may be disallowed when luma and chroma partition types don't satisfy the pre-defined conditions. The condition checking may be taken at a 64×64 block level and passed down to the leaf nodes. In some embodiments, the condition checking is employed only when luma and chroma are applying different partition types in key frames, and the condition checking is not applied to inter frames.

In some embodiments, if one of the following conditions is met, CfL is allowed. Otherwise, CfL is disallowed. (1) If chroma partition is PARTITION_NONE, CfL is allowed. (2) If chroma splits in the same direction as the partition of collocated luma, then CfL is allowed irrespective of the direction of the transform partitions of the luma. For instance, PARTITION_HORZ, PARTITION_HORZ 3, PARTITION_HORZ 4A, PARTITION_HORZ_4B are considered to be in the same direction.

In some embodiments, when a luma partition is PARTITION_NONE at 64×64 in key frames, chroma is always inferred as PARTITION_NONE.

In some embodiments, block partition pruning of the extended H-shape and uneven-4 way partitions is disabled for chroma tree, e.g., to compensate for performance drop.
(A1) In one aspect, some embodiments include a method (e.g., the method 700) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks including a chroma block; (ii) when the chroma block has a same partition direction as a co-located luma block, reconstructing the chroma block using a cross-component prediction mode; and (iii) when the chroma block does not have the same partition direction as the co-located luma block, reconstructing the chroma block without using any cross-component prediction mode. In this way, a decoder may selectively allow or disallow cross-component prediction mode for chroma blocks based on the block partition of the chroma blocks and the block partition and/or transform partition of the co-located luma blocks. As an example, cross component prediction may be disallowed for chroma blocks when the luma and chroma blocks have different block partition directions from the first split at 64×64 (or 64×32 or 32×64) level. For example, at 64×64 level, when luma is using horizontal binary split and chroma is using vertical H-shape split, cross-component prediction is not allowed for all the child nodes for chroma block under this 64×64 node.
(A2) In some embodiments of A1, the method further comprises, when the chroma block has a block size of 64 and is not partitioned, reconstructing the chroma block using the cross-component prediction mode. For example, when chroma blocks are not split at 64×64 (or 64×32 or 32×64) block partition node, cross component prediction mode may be allowed for the node at 64×64 (or 64×32 or 32×64) node regardless of the co-located luma block partition and transform partition.
(A3) In some embodiments of A1 or A2, the method further comprises determining whether to use the cross-component prediction mode for the chroma block without considering any transform partitioning. In some embodiments, the determination of whether to use the cross-component prediction mode is based only on partition directions of the chroma block and co-located luma block. In some embodiments, when luma and chroma blocks have the same direction, either both horizontal directions or both vertical directions, at 64×64 (or 64×32 or 32×64) level, cross-component prediction is enabled for chroma blocks regardless of the transform partition split of the luma blocks.
(A4) In some embodiments of any of A1-A3, the partition direction comprises a horizontal direction or a vertical direction.
(A5) In some embodiments of any of A1-A4, reconstructing the chroma block using the cross-component prediction mode comprises applying the cross-component prediction mode to each child partition for the chroma block. For example, cross component prediction may be allowed for all the child nodes of chroma blocks at one partition node when the co-located luma and chroma blocks have the same block partition directions (e.g., horizontal or vertical) at the partition node. In some embodiments, cross component prediction is allowed for chroma blocks when the luma and chroma blocks have the same block partition directions from the first split at 64×64 (or 64×32 or 32×64) level. For example, at 64×64 level, luma is using horizontal binary split, and chroma is using horizontal H-shape split, and cross component prediction is allowed for all the child nodes for chroma block under this 64×64 node.
(A6) In some embodiments of any of A1-A5, the chroma block has a size of 64 samples by 64 samples. For example, the partition node for the chroma block can be 64×64, 32×64, 64×32, or 32×32.
(A7) In some embodiments of any of A1-A6, all horizontal partitions are considered to be the same direction. For example, the partition direction of horizontal binary split, horizontal H-shape, and horizontal uneven 4-way split (e.g., includes both horizontal uneven 4-way A split and uneven 4-way B split) is horizontal direction.
(A8) In some embodiments of any of A1-A7, all vertical partitions are considered to be the same direction. For example, the partition direction of vertical binary split, vertical H-shape, and vertical uneven 4-way split (including both vertical uneven 4-way A split and uneven 4-way B split) is vertical direction.
(A9) In some embodiments of any of A1-A2 or A4-A8, the method further comprises, when the co-located luma block is not partitioned or transform partitioned, reconstructing the chroma block using the cross-component prediction mode. For example, when there is no block partition split and no transform partition split for the co-located luma blocks at 64×64 (or 64×32 or 32×64) block partition node, cross component prediction mode may be allowed for all the child chroma blocks under this 64×64 (or 64×32 or 32×64) block partition node regardless of the block partition for chroma blocks.
(A10) In some embodiments of any of A1-A2 or A4-A9, the method further comprises, when the chroma block is partitioned in a direction that is perpendicular to a transform partition direction, reconstructing the chroma block without using any cross-component prediction mode. For example, when there is no block partition split at 64×64 (or 64×32 or 32×64) block partition node for co-located luma blocks, the transform partition direction for luma blocks is X, either horizontal or vertical, and the block partition of the chroma blocks at 64×64 (or 64×32 or 32×64) block partition node is perpendicular to X, cross-component prediction is not allowed for chroma blocks.
(A11) In some embodiments of any of A1-A2 or A4-A10, the method further comprises: (i) when a transform partition for the co-located luma block is a quad-tree split and the chroma block has a first type of partition, reconstructing the chroma block without using any cross-component prediction mode; and (ii) when the transform partition for the co-located luma block is the quad-tree split and the chroma block has a second type of partition, reconstructing the chroma block using the cross-component prediction mode. For example, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is one kind of partition split, cross component prediction is not allowed for chroma blocks. As another example, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is not partition_none and horizontal split, cross component prediction is not allowed for chroma blocks.
(B1) In another aspect, some embodiments include a method (e.g., the method 750) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of blocks, including a chroma block; (ii) when the chroma block has a same partition direction as a co-located luma block, encoding the chroma block using a cross-component prediction mode; and (iii) when the chroma block does not have the same partition direction as the co-located luma block, encoding the chroma block without using any cross-component prediction mode.
(B2) In some embodiments of B1, the method further comprises, when the chroma block has a block size of 64 and is not partitioned, encoding the chroma block using the cross-component prediction mode.
(B3) In some embodiments of B1 or B2, the method further comprises determining whether to use the cross-component prediction mode for the chroma block without considering any transform partitioning.
(B4) In some embodiments of any of B1-B3, the partition direction comprises a horizontal direction or a vertical direction.
(B5) In some embodiments of any of B1-B4, encoding the chroma block using the cross-component prediction mode comprises applying the cross-component prediction mode to each child partition for the chroma block.
(B6) In some embodiments of any of B1-B5, the chroma block has a size of 64 samples by 64 samples.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A11 and B1-B6 above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A11 and B1-B6 above). In some embodiments, a memory or non-transitory computer-readable storage medium stores a video bitstream including any of the features (e.g., syntax and encoded information) disclosed herein.

The proposed methods may be used separately or combined in any order. Further, each of the methods (or embodiments), encoder, and decoder may be implemented by processing circuitry (e.g., one or more processors or one or more integrated circuits). For example, the one or more processors execute a program that is stored in a non-transitory computer-readable medium. In the following, the term block may be interpreted as a prediction block, a coding block, or a coding unit (CU).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

Although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks including a chroma block;
when the chroma block has a same partition direction as a co-located luma block, reconstructing the chroma block using a cross-component prediction mode; and
when the chroma block does not have the same partition direction as the co-located luma block, reconstructing the chroma block without using any cross-component prediction mode.

2. The method of claim 1, further comprising, when the chroma block has a block size of 64 and is not partitioned, reconstructing the chroma block using the cross-component prediction mode.

3. The method of claim 1, further comprising determining whether to use the cross-component prediction mode for the chroma block without considering any transform partitioning.

4. The method of claim 1, wherein the partition direction comprises a horizontal direction or a vertical direction.

5. The method of claim 1, wherein reconstructing the chroma block using the cross-component prediction mode comprises applying the cross-component prediction mode to each child partition for the chroma block.

6. The method of claim 1, wherein the chroma block has a size of 64 samples by 64 samples.

7. The method of claim 1, wherein all horizontal partitions are considered to be the same direction.

8. The method of claim 1, wherein all vertical partitions are considered to be the same direction.

9. The method of claim 1, further comprising:
when the co-located luma block is not partitioned or transform partitioned, reconstructing the chroma block using the cross-component prediction mode.

10. The method of claim 1, further comprising:
when the chroma block is partitioned in a direction that is perpendicular to a transform partition direction, reconstructing the chroma block without using any cross-component prediction mode.

11. The method of claim 1, further comprising:
when a transform partition for the co-located luma block is a quad-tree split and the chroma block has a first type of partition, reconstructing the chroma block without using any cross-component prediction mode; and
when the transform partition for the co-located luma block is the quad-tree split and the chroma block has a second type of partition, reconstructing the chroma block using the cross-component prediction mode.

12. A method of video encoding performed at a computing system having memory and one or more processors, the method comprising:
receiving video data comprising a plurality of blocks, including a chroma block;
when the chroma block has a same partition direction as a co-located luma block, encoding the chroma block using a cross-component prediction mode; and
when the chroma block does not have the same partition direction as the co-located luma block, encoding the chroma block without using any cross-component prediction mode.

13. The method of claim 12, further comprising:
when the chroma block has a block size of 64 and is not partitioned, encoding the chroma block using the cross-component prediction mode.

14. The method of claim 12, further comprising determining whether to use the cross-component prediction mode for the chroma block without considering any transform partitioning.

15. The method of claim 12, wherein the partition direction comprises a horizontal direction or a vertical direction.

16. The method of claim 12, wherein encoding the chroma block using the cross-component prediction mode comprises applying the cross-component prediction mode to each child partition for the chroma block.

17. The method of claim 12, wherein the chroma block has a size of 64 samples by 64 samples.

18. A non-transitory computer-readable storage medium storing a video bitstream that is generated by a video encoding method, the video bitstream comprising:
a plurality of encoded blocks, including encoded information for a chroma block and a co-located luma block; and
wherein the video encoding method comprises:
when the chroma block has a same partition direction as the co-located luma block, encoding the chroma block using a cross-component prediction mode; and
when the chroma block does not have the same partition direction as the co-located luma block, encoding the chroma block without using any cross-component prediction mode.

19. The non-transitory computer-readable storage medium of claim 18, wherein the video encoding method further comprises, when the chroma block has a block size of 64 and is not partitioned, encoding the chroma block using the cross-component prediction mode.

20. The non-transitory computer-readable storage medium of claim 18, wherein the partition direction comprises a horizontal direction or a vertical direction.
